(19) United States
(12) Patent Application Publication
(10) Pub. No.: US 2023/0142039 A1
(43) Pub. Date: May 11, 2023

(54) CLEANING A PRINT APPARATUS

(71) Applicant: Hewlett-Packard Development Company, L.P., Spring, TX (US)

(72) Inventors: Yossi YAACOBOV, Nes Ziona (IL); Tsafi ZION SHTIVI, Nes Ziona (IL); Michel ASSENHEIMER, Nes Ziona (IL); Yaniv YONA, Kiryat-Gat (IL); Amiran LAVON, Nes Ziona (IL)

(73) Assignee: Hewlett-Packard Development Company, L.P., Spring, TX (US)

(21) Appl. No.: 17/996,905

(22) PCT Filed: Apr. 24, 2020
(86) PCT No.: PCT/US2020/029693

§ 371 Date: Oct. 21, 2022

(51) Int. Cl. G03G 21/00

(52) U.S. Cl. CPC G03G 21/007

(57) ABSTRACT

In one example a method comprises moving, by a processor, a photoreceptor of a print apparatus. The photoreceptor is movable between a fully engaged position in which the photoreceptor is to engage a transfer member of the print apparatus to transfer an image from the photoreceptor to the transfer member and a fully disengaged position in which the photoreceptor is remote from the transfer member. The method comprises moving, by a processor, the photoreceptor to an intermediate position between the fully engaged and fully disengaged positions. The method comprises engaging, by a processor, a cleaning system of the print apparatus with the photoreceptor when the photoreceptor is in the intermediate position.

### BACKGROUND

In some print apparatuses, a rotatable transfer member is to transfer an image to a substrate. A rotatable member may transfer the image to the rotatable member.

### BRIEF DESCRIPTION OF DRAWINGS

Examples will now be described, by way of non-limiting example, with reference to the accompanying drawings, in which:

FIG. 1 is a simplified schematic of an example printing apparatus;

FIG. 2 is a simplified schematic of an example photoconductor and cleaning station of a print apparatus;

FIGS. 3A-3C is a simplified schematic of a photoconductor in three positions;

FIG. 4 is a simplified schematic of an example print apparatus;

FIG. 5 is a simplified schematic diagram of example modes of operation of a print apparatus;

FIG. 6 is a flowchart of an example of a method;

FIG. 7 is a flowchart of an example method; and

FIG. 8 is a simplified schematic of an example machine-readable medium in association with a processor.

FIG. 9 is a diagram schematically indicating advection times for example cleaning element pairs when an example photoconductor is in a disengaged and semi-engaged position.

### DETAILED DESCRIPTION

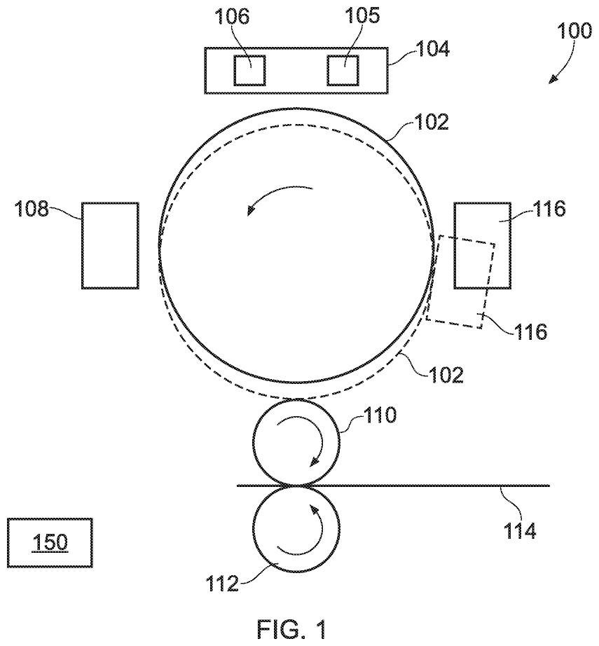

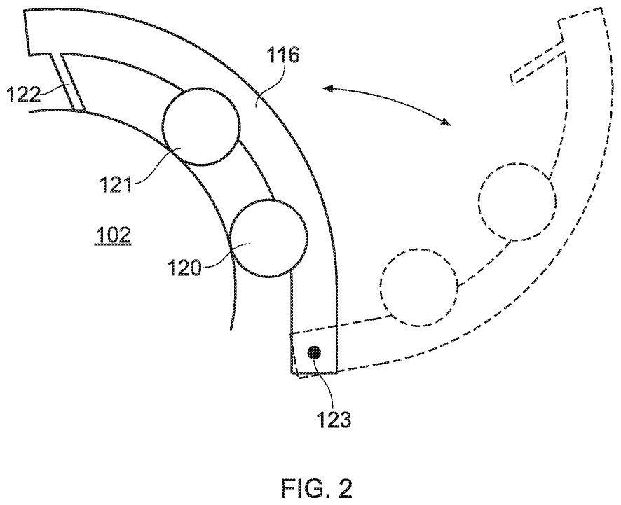

In an example print apparatus, which may comprise a liquid electro-photography (LEP) printing device, a fluid image (for example an inked image, for example an image formed by fluid as will be described below) may be formed on a substrate by uniformly charging a photoconductive element and then selectively discharging areas to form a latent image on the photoconductive element that is then coated with a printing fluid (such as an ink, for example electro-ink). FIG. 1 schematically shows an example print apparatus 100, which may comprise a LEP printing device. The print apparatus 100 comprises a photoconductor 102, which may also be referred to as a photoreceptor, and which comprises a photoreceptive, or photoconductive, element on which a latent image is to be formed. In some examples, the photoconductor 102 may comprise a photoreceptive, or photoconductive, drum, such as a rotatable drum and may comprise the photoreceptive, or photoconductive, surface on the outside of the drum, e.g. a cylindrical exterior surface. In some examples the photoconductor 102 may comprise a photoreceptive foil, for example a photoreceptive foil mounted on a drum. In some examples, the photoconductor 102 may comprise a photoreceptive, or photoconductive, belt (for example a movable belt). In some examples the photoconductor 102 may comprise a heatable element. The photoconductor 102 is rotatable (as indicated by the arrow) and therefore a given area of the exterior surface of the photoconductor 102 may pass by a number of stations of the print apparatus 100 to now be described. The print apparatus 100 comprises a latent image forming unit 104 which comprises a charging station 105 and a laser writing system 106 (system 106 may, in some examples, comprise an LED). At the latent image forming unit 104 the charging station 105 may be to apply a uniform charge (e.g. a static charge) to a surface (e.g. an exterior surface) of the rotating photoconductor 102 as the photoconductor 102 rotates about the charging station 105. The charging station 105 may comprise a charging roller or a corona device (such as a corona wire) to apply the uniform charge to the photoconductor 102 which may, in some examples, be in contact with the charging station 105 but in other examples may not be in contact with the charging station 105. The laser writing system 106 is to selectively discharge areas of the photoconductor 102 to form a latent image, these discharged areas forming the latent image correspond to an image to be printed by the print apparatus 100. The print apparatus 100 also comprises a printing fluid developer unit (such as an ink developer unit) 108. The developer unit 108 is to engage, for example to form a nip, with the photoconductor 102 and is to apply a fluid, for example a printing fluid such as an ink, to the photoconductor 102 to develop a fluid image on the surface of the photoconductor 102. For example, the developer unit 108 may be to apply a dielectric fluid such as oil to the photoconductor 102, the dielectric fluid comprising printing fluid (e.g. ink) particles suspended, e.g. charged immersed, in a liquid carrier. The fluid applied to the photoconductor 102 by the developer unit 108 may therefore comprise charged particles (e.g. charged and coloured particles). When the fluid is applied to the photoconductor 102, charged fluid particles (e.g. ink particles) are attracted to the discharged portion(s) of the photoconductor 102. In other words, the charged fluid particles are attracted to the latent image and in this way, an image of printing fluid is formed on the surface of the photoconductor 102 (at those portions corresponding to the latent image). In this way, a fluid image (e.g. an inked image) is developed on the surface of the photoconductor 102. The print apparatus 100 comprises a movable component 110 that is to transfer an image to a substrate 114. The movable component 110 may comprise a rotatable component (as shown in FIG. 1). The movable component 110 may comprise a transfer member, or an intermediate transfer member. The component 110 may comprise a drum or belt or movable component (e.g. photoreceptive or photoconductive) around which may be wrapped a heatable element such as a blanket, or the component 110 may comprise other than a blanket, for example a different type of heatable component. In these examples, rotatable engagement between the photoconductor 102 and the component 110 transfers the fluid image from the photoconductor 102 to the component 110 and the component 110 rotates to transfer the image to the substrate 114 (for example, via a nip-like impression created between the component 110 and an impression cylinder 112). The blanket on the component 110 may be to heat the image prior to the transfer to the substrate 114. In some examples an image may be directly transferred from the photoconductor 102 to the substrate 114 (e.g. in a dry toner device). The print apparatus 100 may comprise other elements that are omitted from FIG. 1 for brevity such as a discharging station to remove the uniform charge applied to the photoconductor 102 at 104. The print apparatus 100 comprises a cleaning station 116 (or a cleaning module or a cleaning system) which will be described in more detail with reference to FIG. 2.

As will be discussed in more detail with reference to the figures below, the photoconductor 102 is movable between a fully engaged position (not shown in FIG. 1) in which the photoconductor 102 is to engage the movable component 110 to transfer an image formed on a surface of the photoconductor 102 to the movable component 110 and a fully disengaged position, which is shown by the solid lines in FIG. 2, in which the photoconductor 102 is remote from the movable component 110. The photoconductor 102 is therefore movable to an in-between position (or a semi-engaged) position, which is a position in between the fully engaged and fully disengaged positions and is shown by the dotted line in FIG. 1. The cleaning station 116 is movable between a disengaged position (in which the cleaning station 116 is remote from the photoconductor 102) shown in solid lines in FIG. 1 and an engaged position (in which the cleaning station 116 is to engage the photoconductor 102, e.g. to cool and/or clean the photoconductor, as will be described below) shown in dotted lines in FIG. 1. As shown in FIG. 1 by the dotted line configuration of the cleaning station 116 and the photoconductor 102, and as will be described in more detailed below, some examples herein relate to the cleaning station 116 engaging (shown in dotted lines) the photoconductor 102 when the photoconductor 102 is in a position in between the engaged and fully disengaged positions (the position of the photoconductor 102 shown in dotted lines). The print apparatus comprises a controller 150. The controller 150 is to control the function of a number of elements of the print apparatus 100, for example any number of the components 102-112 as described above. As will be described below, the controller 150 is to cause the cleaning station 116 to engage the photoconductor 102 when the photoconductor 102 is in a position between the engaged and fully disengaged positions (as indicated by the dotted line positions of 116 and 102 in FIG. 1).

FIG. 2 shows the cleaning station 116. The cleaning station 116 may be to clean and/or cool a surface of the photoconductor 102. The cleaning station 116 comprises a first cleaning element 120, a second cleaning element 121, and a wiper 122. The first and second cleaning elements 120, 121 are depicted schematically as a roller for illustrative purposes. The first and second rollers 120 may each, or both, comprise a sponge roller and/or a wetting roller and/or a squeegee roller). However, in other examples the cleaning elements 120, 121 may comprise other than a roller. In these examples, one or both of the cleaning elements 120, 121 may comprise a squeegee (for example a resiliently deformable element) that is to indent a sponge to cause fluid to flow from the sponge. The wiper 122 may comprise a wiper blade. The cleaning station 116 is movable about a point 123. Point 123 may comprise a pivot point and the cleaning station 116 may be pivotally movable (or movable in a hinged fashion about the pivot point). The cleaning station 116 is movable about the point 123 between an engaged position (shown in solid lines in FIG. 2) in which the cleaning station 116 engages the photoconductor 102 and a disengaged position (shown in dotted lines in FIG. 2) in which the cleaning station is remote from the photoconductor 102. The cleaning station 116 may be to prepare the photoconductor 102 (e.g. the chargeable external surface thereof) for a subsequent print operation following the transfer of the image to the movable component 110 by cleaning off any residual printing fluid and contamination before a new print cycle is commenced. One, or both, of the rollers 120, 121 may be to clean residual ink from the surface of the photoconductor 102. The cleaning station may be provided for the effective cleaning and/or cooling of the photoreceptor 102. The cleaning station 116 may be to clean any remnant contaminants from the surface of the photoreceptor 102. The sponges may be to apply a layer of cleaning fluid onto the surface of the photoconductor 102. For this purpose, the or each roller 120, 121 may be connected to a supply of cleaning fluid (for example, cold cleaning fluid) and may be to contact the surface of the photoconductor to form a nip. The cleaning fluid may comprise a dielectric fluid such as oil. As fluid is applied to the photoconductor 102 by one of the elements 120, 121 it is metered by the wiper blade 122. Put another way, the wiper blade 122 may be to ensure that the layer of cleaning fluid on the photoconductor 102 downstream of the wiper 122 is at a constant, or uniform, thickness. For this purpose the wiper 122 may comprise an angle, contact force, and deflection coefficient (or stiffness) in addition to material properties which may affect the thickness of the cleaning fluid after the photoconductor 102 has advanced under the wiper 122, and which are therefore properties that affect the thickness at which cleaning fluid is applied to the photoconductive surface of the photoconductor 102 after the wiper blade 122. The cleaning station 116, by virtue of the rollers 120, 121 and wiper 122, may therefore be to supply a constant flow of cleaning fluid at a constant thickness to the photoconductive surface of the photoconductor 102. As FIG. 2 shows, roller 120 may be referred to as a lower roller and roller 121 may be referred to as an upper roller.

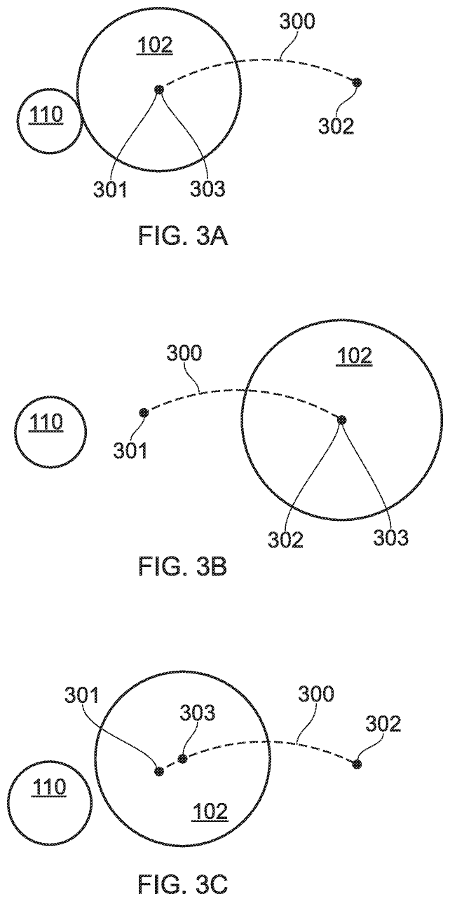

FIGS. 3A-3C show the photoconductor 102 and movable component 110 (which, as above may comprise a rotatable drum). The movable component 110 (which will be hereinafter referred to as the transfer member 110) may be movable in the sense that it is rotatable but the position of the transfer member 110 in the print apparatus (e.g. relative to another component thereof) may be fixed. In other words, the location and/or position of the transfer member 110 in the print apparatus 100 may not be movable. By contrast, the photoconductor 102 is movable, and is movable both into, and out of, engagement with the transfer member 110. FIG. 3A shows the photoconductor in an “engaged” or “fully engaged” position, FIG. 3B shows the photoconductor in a “disengaged position” or “fully disengaged position”, and FIG. 3C shows the photoconductor in a “semi-engaged” or “semi-disengaged” position. In the engaged position of FIG. 3A, the photoconductor 102 is moved into contact with the transfer member 100 to adopt the position that it is to adopt during printing. In other words, in the fully engaged position, the photoconductor 102 is to perform a print operation. In some examples, in the fully engaged position, the photoconductor 102 may be to form a nip to transfer the fluid image to the transfer member 110. Herein, by forming a nip between two rollers it may be understood to be the two rollers coming together to provide a finite contact area between the rollers. In other examples, in the fully engaged position the photoconductor 102 may not form a nip and a fluid image may be transferred without contact between the photoconductor 102 and the transfer member 110. In other words, the photoreceptor 102 in the fully engaged position may be in sufficient proximity to transfer a fluid image formed thereon to the transfer member 110 during a print operation (for example in a print operation utilising a dry toner where toner particles may be electrostatically transferred through the air. In some examples the transfer member 110 may comprise a blanket, for example a heated blanket formed thereon such as wound around a drum of the member, to receive the flluid image from the photoreceptor 102. In these examples, in the fully engaged position the photoreceptor 102 may be to compress the blanket, for example to compress the blanket by a target, e.g. pre-determined, value, for example calibrated during manufacturing, for the print apparatus to perform a successful print operation. For example, the photoreceptor 102 in the fully engaged position may be to compress the blanket to form a nip between the photoreceptor 102 and the blanket. For example, when in the fully engaged position the transfer member 110 may have a compressed diameter.

In the disengaged position of FIG. 3B the photoconductor 102 is remote from the transfer member 110. In some examples, the disengaged position of FIG. 3B may be the “home” or “parked” position of the photoconductor 102. In these examples, an actuator may control the position of the photoconductor 102. For example, the actuator may comprise a displacement actuator. In these examples, the disengaged position of FIG. 3B may correspond to the home position of the actuator that controls movement of the photoconductor. Therefore, the disengaged position of the photoconductor 102 may correspond to the home position of a displacement actuator. In these examples (where an actuator controls the movement and/or position of the photoconductor) the actuator's position may be calibrated. The photoconductor 102 may therefore be movable along a trajectory between two extreme positions, an extreme engaged position and an extreme disengaged position. The engaged positon and disengaged position, shown in FIGS. 3A and 3B, respectively, may each be one of the extreme positions of the photoconductor 102.

The semi-engaged position shown in FIG. 3C may be a position that is not the fully engaged position shown in FIG. 3A and not the fully disengaged position shown in FIG. 3B. The semi-engaged position may therefore be an in-between position, or intermediate position, between two positions that are each at a different extreme of the range of motion of the photoconductor 102. In other words, the semi-engaged position may comprise any position of the photoconductor 102 that is not the fully engaged or fully disengaged positions, or any position of the photoconductor 102 between the fully engaged or fully disengaged position. In some examples, the semi-engaged position of the photoconductor may be a position in which the photoconductor 102 is as close as possible to the fully engaged position without being in the fully engaged position. For example, the fully engaged position of the photoconductor (indicated at 301 in FIG. 3) may correspond to a distance ‘x2’ that the photoconductor 102 has to move from its home position, (the disengaged position of FIG. 3B) to its fully engaged position. In this example, the distance the photoconductor moves to the semi-engaged positon (position 302 in FIG. 3) may be x2−ω with ω being small. In other words, in these examples, w may be approximately 0 but not equal to 0 so that the semi-engage position is as close as possible to the fully engaged position. In some examples, ω may be such that x2/ω<0.5. As stated above, in some examples the photoconductor 102 in the fully engaged positon may be to form a nip with the transfer member 110. In these examples the photoconductor 102 in the semi-engaged position may not form a nip. In other examples the photoconductor 102 in the semi-engaged position may form a nip (but in these examples the nip force would be less than the nip force in the fully engaged position). For example, in the fully engaged position the photoconductor 102 may be to form a nip with the transfer member 110 of nip force y Newtons and, in the semi-engaged position the photoconductor 102 may be to form a nip with the transfer member 110 having a nip force of less than y. Therefore, in some examples the contact area between the photoconductor 102 and the transfer member 110 when the photoconductor 102 is in its semi-engaged position is less than the contact area between the photoconductor 102 and the transfer member 110 when the photoconductor 102 is in its fully engaged position. As stated above, in some examples in the fully engaged position the photoconductor 102 is to compress the transfer member 110 (e.g. a blanket thereon). In these examples in the semi-engaged position the photoconductor 102 may be to compress the transfer member 110 by an amount less than the amount that the transfer member 110 is compressed by the photoconductor 102 when in the fully engaged position. For example, in the fully engaged positon the photoconductor 102 may be to compress the transfer member 110 (e.g. a blanket thereon) by z and in the semi-engaged position the photoconductor 102 may be to compress the transfer member 110 by less than z. In other words, in the semi-engaged position there may be a minor compressive force. For example, in the semi-engaged position the photoconductor 102 may be to compress the transfer member 110 such that its compressed diameter is as close as possible to the compressed diameter when the photoconductor 102 is in the fully engaged position without being equal. For example, the compressed diameter of the transfer member 110 when the photoconductor 102 is in the semi-engaged position may be larger than the compressed diameter of the transfer member 110 when the photoconductor 102 is in the fully engaged position. Of course, in some examples, in the semi-engaged position, the photoconductor 102 may contact the transfer member 110. In other examples, in the semi-engaged position, the photoconductor 102 may not contact the transfer member 110.

The possible positions that the photoconductor 102 can adopt are shown in FIGS. 3A-3C by the dotted line 300 having endpoints 301, 302, the dotted line representing a trajectory, or possible positions, of the photoconductor 102 and each endpoint 301, 302 representing an extreme position of the photoconductor 102. The trajectory 300 of the photoconductor 102 may be confined to a two-dimensional plane and therefore each endpoint 301, 302 may be an opposite end of the trajectory of the photoconductor 102. In FIG. 3A, in the engaged position, a centrepoint 303 of the photoconductor 102 is at the first end point 301 (leftmost in the figures) being the (extreme) location at which the photoconductor 102 is in the engaged position. In FIG. 3B, in the engaged position, a centrepoint 303 of the photoconductor 102 is at the second end point 302 (rightmost in the figures) being the (extreme) location at which the photoconductor 102 is in the disengaged position. In FIG. 3C, the centrepoint 303 of the photoconductor is in an intermediate position 305 in-between the two endpoints 301 and 302 as the photoconductor 102 is in the in-between, or intermediate, semi-engaged position.

As stated above, in the fully engaged position (FIG. 3A) the photoconductor 102 may be in position to perform a print operation, for example in a position to transfer a fluid image formed thereon to the transfer member 110, and/or in the engaged position, the photoconductor 102 may form a nip with the transfer member 110 (e.g. to transfer the image thereto). As stated above, in the semi-engaged position (FIG. 3C), the photoconductor 102 may contact, e.g. touch, the transfer member 110. For example, as stated above, there may be a small contact area between the photoconductor 102 and the transfer member 110 in the semi-engaged position than in the fully engaged position. In other examples the photoconductor 102 may not contact the transfer member 110. The photoconductor 102 in the semi-engaged position may be proximate the transfer member 110. In other words, in the semi-engaged position, the photoconductor 102 may be proximate to the transfer member 110 (but, for example, not proximate enough to perform a print operation, for example as close as possible to the transfer member 110 without being in its fully engaged position) and may in some examples engage (e.g. touch) the transfer member 110. Therefore, although the photoconductor 102 is depicted in FIG. 3C as not touching the transfer member 110 this is for illustrative purposes to schematically distinguish the depiction of the semi-engaged position from the fully engaged position. In the semi-engage position the photoconductor 102 may touch, e.g. be in contact with, the transfer member 110 (but, for example, without enough force to form a nip as in the engaged position).

Although not shown in FIG. 3 the cleaning station 116 is movable between its engaged position (where it engages the photoconductor 102) and its disengaged position (where it is remote from the photoconductor 102), as depicted in FIG. 2, irrespective of the position of the photoconductor 102. Put another way, the photoconductor 102 and cleaning station 116 are both movable independent of one another. The cleaning station 116 is therefore movable into engagement with the photoconductor 102 (where the rollers 120, 121 and wiper 122 come into contact with the surface of the photoconductor 102 to coat the surface with cleaning fluid and to meter the cleaning fluid) when the photoconductor 102 is in its fully engaged position, its semi-engaged position, and/or its fully disengaged position. This leads to various configurations that the photoconductor 102, transfer member 110, and the cleaning station 116, can adopt as the photoconductor 102 may be in any one of its engaged, semi-engaged, or disengaged positions with the cleaning station engaged or disengaged. As shown in FIGS. 3A-C, the photoconductor 102 is movable into engagement with the transfer member 110, for example, the photoconductor 102 may be pivotable about a pivot point and may therefore be pivotably movable into engagement with the photoconductor 102, with the cleaning station 116 either engaged or disengaged. These configurations may be used during a “READY-TO-PRINT” state, a “PRE-PRINT” state, and/or a “PRINT” state of the print apparatus 100 to be described below.

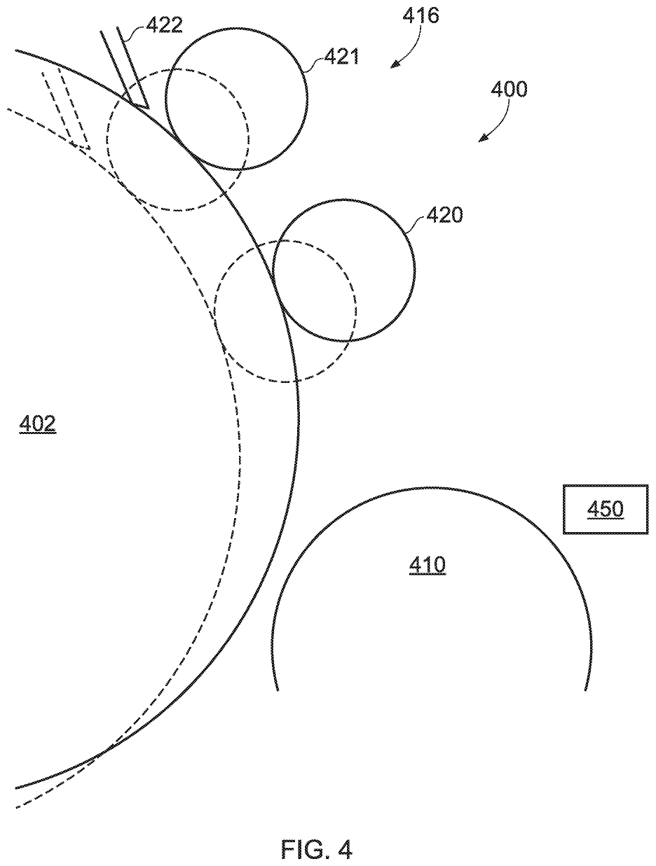

FIG. 4 shows an example print apparatus 400, which may comprise the print apparatus 100 as described above and therefore like features will be denoted with like reference numerals. The print apparatus 100 as described above may comprise the print apparatus 400 as shown in FIG. 4. The print apparatus 400 comprises a photoconductor 402 (which may comprise the photoconductor 102 as described above), a cleaning station 416 (which may comprise the cleaning station 116 described above) and a controller 450 (which may comprise the controller 150 as described above) for the print apparatus 400. The photoconductor 402 is movable between a fully engaged position (as described above with reference to FIG. 3A) in which the photoconductor 402 is to engage a movable component 410 (e.g. an intermediate member such as a transfer member, for example a rotatable drum, for example comprising a heated blanket thereon) to transfer an image formed on a surface of the photoconductor 402 to the movable component 410 (hereafter, transfer member 410) and a fully disengaged position (as described above with reference to FIG. 3B) in which the photoconductor 402 is remote from the transfer member 410. The cleaning station 416 is to clean and/or cool a surface of the photoconductor 402 and is movable between an engaged position in which the cleaning station 416 is to engage the photoconductor 402 to clean and/or cool a surface of the photoconductor and a disengaged position in which the cleaning station 416 is remote from the photoconductor 402 (as shown in FIG. 2). In the engaged position, a first element 120 and/or a second element 121 and/or a wiper blade 122 is engaged with the surface of the photoconductor 402 to coat and meter a layer of cleaning fluid to the surface to clean and/or cool the surface of the photoconductor 402, e.g. as described above.

The controller 450 of the print apparatus 400 is to control the position of the cleaning station 416 and may be to control the position of the photoconductor 402. The controller 450 may be to place the print apparatus 400 in a “READY-TO-PRINT” state, a “PRE-PRINT” state, and/or a “PRINT” state. In each of these three states the cleaning station 416 and the photoconductor 402 may be placed in one of their possible positions (as described above) and the controller 450 may be to control the position of the cleaning station 416 and the photoconductor 402 to place the print apparatus 400 in one of its states. A PRINT state of the print apparatus 400 may be a state in which the apparatus 400 is to perform a print operation. In the PRINT state, each of the components (e.g. as described above including the developer unit and latent image forming unit etc.) may be in the positions that they are to adopt during a print operation. The READY TO PRINT (or “READY) state may be a state of the print apparatus 400 where the print apparatus is not in a PRINT state but is nevertheless switched ON. In the READY state the print apparatus may be on standby to print. The PRE-PRINT state may comprise a state in which the print apparatus 400 is transitioning to the PRINT state (e.g. from the READY state).

As for the cleaning station 116 described above, the cleaning station 416 comprises a first cleaning element 420, a second cleaning element 421, and a wiper 422. The first and second cleaning elements 420, 421 are depicted schematically as a roller for illustrative purposes. The first and second rollers 420 may each, or both, comprise a sponge roller and/or a wetting roller and/or a squeegee roller). However, in other examples the cleaning elements 420, 421 may comprise other than a roller. In these examples, one or both of the cleaning elements 420, 421 may comprise a squeegee (for example a resiliently deformable element) that is to indent a sponge to cause fluid to flow from the sponge. In some examples the cleaning station 416 comprises one cleaning element and one wiper. Occasionally, a wiper of the cleaning station 416 may come into contact with a surface (e.g. a photoconductive surface on which the fluid image is to be formed) of the photoconductor 402 when the surface of the photoconductor 402 and/or the wiper is dry. This phenomenon will be referred to as “dry contact”. The photoconductive surface may be dry prior to receiving fluid (e.g. printing fluid from a developer unit or cleaning fluid from the cleaning station 416). Dry contact may therefore occur when the photoconductor and/or the wiper is newly-installed (for example due to a parts replacement or maintenance). In other words, in some instances, the wiper and/or the photoconductive surface of the photoconductor 402 may be dry prior to printing. This may lead to damaging in the photoconductor 402 and/or the wiper 422. For example, the dry contact could lead to a stick-slip contact that could cause the cleaning station 416 to bounce, since the dry wiper may stick to the photoconductive surface rather than wetly gliding over the surface. This type of bouncing may damage the wiper or the photoconductive surface, or if an unusual perturbation is detected by the controller 450 (e.g. movement of the cleaning station) then the controller 450 may force the print operation to stop. Any damage may be subtle but even minor damage may contribute to a decrease in the print quality by introducing print quality defects. Dry contact may arise due to the following. With additional reference to FIG. 2, when the cleaning station 116 is rotated into engagement with the photoconductor 102 (e.g. when it is placed in its engaged position), the first roller 120 contacts the exterior surface of the photoconductor before the second roller 121, and the second roller 121 contacts the surface of the photoconductor 102 before the wiper 122. The rollers 120, 122, which cause the surface of the photoconductor 102 to be coated with cleaning fluid (e.g. a dielectric fluid such as oil) therefore contact the surface of the photoconductor 102 before the wiper 122. The time delay between cleaning fluid being applied to the surface of the (rotating) photoconductor by one of the cleaning elements 120, 121 (e.g. the first of the two elements to contact the photoconductor) and the cleaning fluid reaching the wiper blade may be referred to as the “advection time delay” or “advection time window”. The length of time under which a dry (e.g. new or replaced following maintenance) wiper and/or photoconductor are in contact are therefore dependent on the advection time delay. Some examples herein relate to increasing the advection time delay. In this way, if the advection time delay is increased then the cleaning fluid has more time to reach the wiper blade 122, thereby decreasing the time in which the wiper and photoconductor are in dry contact, with no cleaning fluid flowing between them.

Referring again to FIG. 4, the controller 450 is to cause the cleaning station 416 to engage the photoconductor 402, e.g. to clean and/or cool the photoconductor, when the photoconductor 402 is in a position between the engaged and fully disengaged position. In other words, the controller 450 is to cause the cleaning station 416 to engage the photoconductor 402 when the photoconductor 402 is in a position between the fully engaged and fully disengaged position. The controller 450 may be to cause the cleaning station 416 to engage the photoconductor 402 when the photoconductor 402 is in the semi-engaged position as described above. For example, the controller 450 may be to cause the cleaning station 416 to engage the photoconductor 402 when the photoconductor 402 is in an intermediate position. For example, the controller 450 may be to cause the cleaning station 416 to engage the photoconductor 402 when the photoconductor 402 is in any position between its two extreme positions. The controller 450 may therefore be to cause the cleaning station 416 to engage the photoconductor 402 when the photoconductor 402 is in the position depicted in FIG. 3C as described above. This is shown in FIG. 4 by the solid and dotted lines. The solid lines indicate the cleaning station 416 engaged with the photoconductor 402 when the photoconductor 402 is in the semi-engage (or in-between or intermediate etc.) position. The dotted lines show the cleaning station 416 engaged with the photoconductor when in the (fully) disengaged position (e.g. the position shown in FIG. 3B). As shown in FIG. 4, when the cleaning station 416 is rotated (or pivoted) into engagement with the photoconductor 402, the cleaning station 416 engages the photoconductor in a different position when the photoconductor 416 is in the semi-engaged (as shown in solid lines) vs when in the disengaged (as shown in dotted lines). As also shown in FIG. 4, this effectively changes the angle at which the cleaning station 416 engages the surface of the photoconductor 402, meaning that the one of the sponge rollers of the cleaning station 416 engages the photoconductor sooner and the wiper engages the photoconductor 416 later (as compared to when the cleaning station 416 engages the photoconductor in its disengaged position), thereby increasing the advection time when the photoconductor 402 is in its semi-engaged position. For example, for one set of upper and lower rollers, the advection time for the lower roller when the photoconductor 402 is in the disengaged position may be approximately 1.2×10⁻¹ ms whereas the advection time when the photoconductor 402 is in the semi-engaged position is approximately 3×10⁻¹ ms—an increase of over 50%.

Therefore, engaging the cleaning station 416 to clean and/or cool the photoconductor 402 when the photoconductor 402 is in the semi-engaged position (depicted in FIG. 4 by solid lines) increases the advection time window. For example, as and stated above, for one given wiper position, dimensions, and angle etc. and two sponges of a set diameter, engaging the cleaning station 416 with the photoconductor 402 when the photoconductor 402 is in the semi-engaged position may increase the advection window by approximately 20 ms A wettability margin, for either sponge, may be defined as follows:

$$wettability margin = \frac{advection time for sponge}{time taken}$$

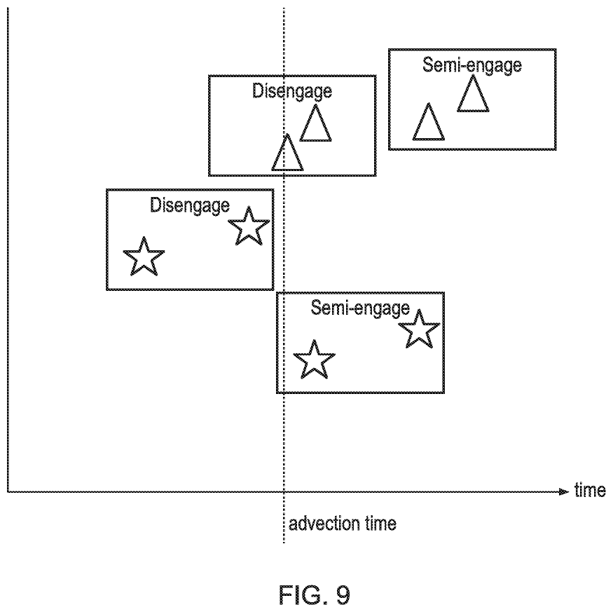

with time taken being the time in between the sponge contacting the photoreceptor and the wiper contacting the photoreceptor. The wettability margin is therefore different for each sponge however an increased wettability margin is in correspondence with a decrease in the conditions under which there may be dry contact between the wiper and the photoconductor. Therefore, by increasing the advection time for the sponges when the cleaning station 416 engages the photoconductor 402 when the photoconductor 402 is in the semi-engage position, the wettability margin may, in turn, be increased. The length of time in which dry contact between the wiper 422 and the photoconductor 402 may occur may therefore be decreased. This is shown schematically in FIG. 9.

FIG. 9 schematically shows how the advection times on the lower axis for various pairs of cleaning elements are increased when these cleaning elements engage the photoconductor when it is in the semi-engaged position (vs the fully disengaged position). The elements may comprise rollers, as stated above. A first pair of cleaning elements is denoted by a triangle and a second pair of cleaning elements is denotes by a star (with the upper, darker, star or triangle in each pair denoting the upper, or top, cleaning roller in the pair and the lower, lighter, star or triangle in each pair denoting the lower, or bottom, cleaning roller). The top and bottom rollers in the pair may have a different diameter, and the each pair of rollers may have a different diameter to the rollers in the other pair. The dotted vertical line in FIG. 9 illustrates the minimum advection time, being the minimum time for fluid having been applied by one of the rollers to pass to the location of the wiper. As FIG. 9 shows, for the first pair of rollers there is insufficient time between the rollers contacting the photoconductor and the wiper contacting the photoconductor when the cleaning station engages the photoconductor when it is in the disengaged position, however when the same (first) pair of rollers engages the photoconductor when in its semi-engaged position the advection time exceeds the minimum advection time (as these are to the right of the dotted vertical line). FIG. 9 also shows that, for the second set of rollers, while the rollers exceeds the minimum advection time when the cleaning station engages the photoconductor when in its disengaged position, the advection time is improved when the cleaning station engages the photoconductor when in its semi-engaged position. In either example therefore the advection time may be increased when the cleaning station engages the photoconductor when in its semi-engaged position.

As stated above with reference to FIGS. 3A-3C, when the photoconductor 402 is in its fully engaged position (FIG. 3A), the photoconductor 402 may form a nip with the movable component 410 of the print apparatus. Therefore, when the cleaning station 416 engages the photoconductor 402 in the semi-engage position, the photoconductor 402 may not form a nip with the movable component 410 (e.g. a rotatable component) of the print apparatus 400. In other examples however, the photoconductor 402 may engage (e.g. touch) the component 410 in this position, although in other examples there may be no contact between the photoconductor 402 and component 410. The controller 450 may therefore be to move the cleaning station 416 into engagement with the photoconductor 402 when the photoconductor 402 is engaged with (e.g. touches) the transfer member 410, for example is as close as possible to the transfer member 410 without being in the fully engaged position, for example as described above with reference to FIG. 3C. For example, this “as close as possible” minimal contact may enable an efficient heat transfer between the transfer member 410 and photoconductor 402 and may minimise any damage due to the contact between the member 410 and the photoconductor 402. As stated above, the controller 450 may be to cause the print apparatus 400 to operate in different modes of operation. For example, the controller 450 may be to cause the print apparatus 400 to operate in a READY state, a PRE-PRINT state and a PRINT state. In the READY state the transfer member 410 may be rotating (for example at a slow speed relative to their speed of rotation during the PRINT state), photoconductor 420 may be in its semi-engaged position, and the cleaning station 416 may be disengaged from the photoconductor 402. Therefore, to place the print apparatus 400 in its READY state the controller may be to cause the transfer member 410 to rotate, place the photoconductor 402 in its semi-engaged position and disengage the cleaning station 416 from the photoconductor 402. In the PRINT state the transfer member 410 may be rotating at full speed, the photoconductor 402 may be in its fully engaged position, and the cleaning station 416 may be engaged to the photoconductor 402. Therefore, to place the print apparatus 400 in its PRINT state the controller may be to cause the transfer member 410 to rotate at full, printing, speed, place the photoconductor 402 in its fully engaged position and to engage the cleaning station 416 with the photoconductor 402. Although the blocks mentioned herebefore have been mentioned in a particular order this is for illustrative purposes and does not imply that this is the order in which the sequence may be performed.

The PRE-PRINT state may be regarded as a transition to print state. From the above, the cleaning station 416 does not engage the photoconductor 402 during the READY state and therefore there is no engagement (dry or wet) between the wiper of the cleaning station 416 and the photoconductor 402. However, in the PRINT state the cleaning station 416 engages the photoconductor 402. During the PRE-PRINT state the cleaning station 416 is brought into engagement with the photoconductor 402 with the photoconductor 402 in the semi-engaged position. Therefore, in the PRE-PRINT state the photoconductor 402 is in its semi-engaged positon and the cleaning station 416 engages the photoconductor 402 so as to increase the advection time window and wetting margin. As stated above, this may decrease the time under which there may be dry contact between the wiper and the photoreceptor surface and, in turn, decrease the risk of damage to the photoreceptor surface and/or the cleaning station and decrease the risk of having defects in the print quality. Therefore, the controller 450 may be to cause the cleaning station 416 to engage the photoconductor 402 to clean and/or cool the photoconductor 402 when the photoconductor 402 is in a position between the fully engaged and fully disengaged positions during the transition from the READY state to the PRINT state (e.g. during the PRE-PRINT state). According to some examples herein, the photoconductor 402 is therefore in its semi-engage position during the READY state and the PRE-PRINT state of the print apparatus 400. The controller 450 may therefore to cause the photoconductor 402 to maintain its position during the READY and PRE-PRINT, e.g. to maintain its position during the transition from the READY to the PRE-PRINT state. In other words, the controller 450 may not cause the photoconductor 402 to change its position during the transition from the READY state to the PRINT state (e.g. in the PRE-PRINT state). In another example, the photoconductor 402 may be in its disengaged position during the READY state. In this example, the PRE-PRINT state may comprise moving the photoconductor 402 to its semi-engaged position and, thereafter, the cleaning station may be engaged.

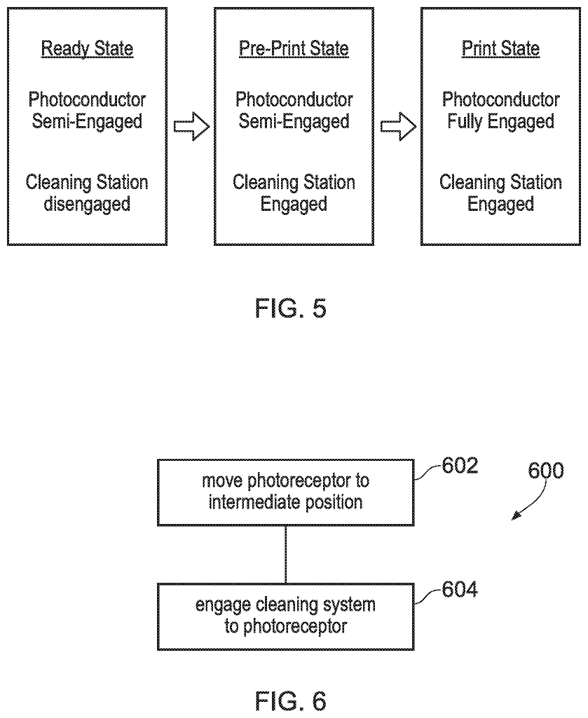

The controller 450 may be to cause the following sequence to occur during the PRE-PRINT state, or during the transition to the PRINT state from the READY state: accelerate the rotational speed of the rotating transfer member 410 (which was rotating slowly in the READY state), place the photoconductor 402 in its semi-engaged position, and move the cleaning station 416 into engagement with the semi-engaged photoconductor 402. The sequence may further comprising moving the photoconductor 402, with the cleaning station 416 engaged, into the fully engaged position with the transfer member 410. There may then be a delay to ensure the components are ready for printing. As above, during PRINT, the controller 450 may be to engage the photoconductor 402, with the engaged cleaning station 416, with the transfer member 410 (e.g. place the photoconductor 402, with the cleaning station 416 engaged, into its fully engaged position). This sequence of operation, with the state (e.g. position) of the photoconductor 402 and cleaning station 416 is summarised in FIG. 5. As shown in FIG. 5, the photoconductor 402 is not to be placed in its engaged or disengaged positon during the READY or PRE-PRINT states, but rather is in its semi-engaged position in both states and therefore the photoconductor's position may not change between the READY and PRE-PRINT state, but is the same (semi-engage) in both states. As also shown in FIG. 5, the cleaning station is engaged during the PRE-PRINT and PRINT states but disengaged in the READY state.

As stated above with reference to FIGS. 3A-3C, when the photoconductor 402 is in the fully engaged position, the photoconductor 402, may form a first contact area with the transfer member 410 and, when in the disengaged position, the photoconductor 402 may form a second contact area with the transfer member 410, the second contact area being less than the first contact area. When in the engaged position and the semi-engaged, the photoconductor 402 may be to compress the transfer member 410 such that the compressed diameter of the transfer member 410 is larger when the photoconductor 402 is in the semi-engaged position than when the photoconductor 402 is in the engaged position.

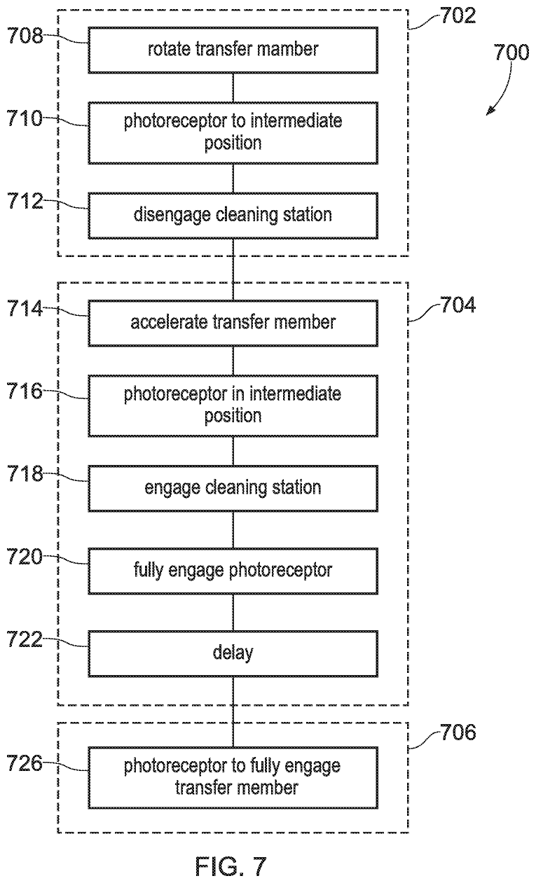

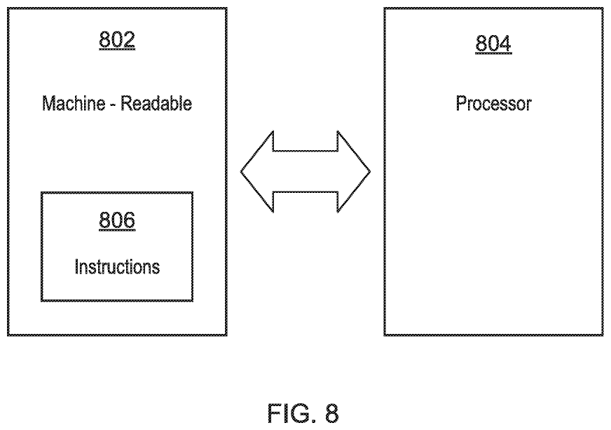

The controller 450 may therefore be to control the print apparatus 400 and may be to control the positions of any number of components of the print apparatus 400 that are movable (e.g. the photoconductor 402, cleaning station 416 which may both be movable, e.g. pivotable, about a fixed point, e.g. a pivot). The controller 450 may therefore be to cause the photoconductor 402 to pivot into engagement with the transfer member 410 (e.g. into the engaged position or semi engaged position) or out of engagement (e.g. to the disengaged position), e.g. with reference to FIGS. 3A-3C. The controller 450 may be to cause the cleaning station 416 to pivot into engagement with the photoconductor 402 and out of engagement to disengage the photoconductor 402, e.g. with reference to FIG. 2. The controller 450 sets the conditions under which cleaning fluid is applied to the photoconductive surface of the photoconductor 402 which, as stated above, can increase the wetting margin which decreases the time during which dry conditions may exits. This reduces the instances of damage (e.g. to a wiper of the cleaning station 416 and/or to the photoconductive surface of the photoconductor 402) but also may provide additional design degrees of freedom to the apparatus 400. For example, engaging the cleaning station 416 to the photoconductor 402 when the photoconductor 402 is in its engaged position may mean that sponges of varying diameter may be used in the cleaning station 416. For example, if a sponge roller were used in the cleaning station that was more abrasive to provide an improved cleaning then this may increase the torque to drive the sponge roller (e.g. to rotate the sponge roller) at a target speed. To overcome the torque increase the sponge diameter may be decreased, however a decrease in the sponge diameter may increase the time during which dry contact may occur between the photoconductive surface and a wiper of the cleaning station. However, by engaging the cleaning station 416 with the photoconductor 402 when the photoconductor 402 is in the semi-engage position the time window within which dry contact may occur can be decreased as discussed above to accommodate differing sponge diameters. In turn, this increases the degrees of freedom that are available to optimise the wiper of the cleaning station. As mentioned above, increasing the wetting margin may extend the lifespan of the photoconductive surface of the photoconductor and/or a wiper of the cleaning station in addition to keeping the photoconductor and/or wiper cleaner. As the controller 450 may be to control the positions of the photoconductor 402 and the cleaning station 416, and may be to control the position of the photoconductor 402 when the cleaning station 416 engages the photoconductor 402 (e.g. to be in the semi-engage position), the controller 450 is able to be programmed to cause a given print apparatus 400 (having a photoconductor and cleaning station) to operate in the manner discussed above. For example a print apparatus 400 whose controls are to cause a cleaning station to engage a photoconductor in the fully disengaged position may be programmed (e.g. re-programmed) to cause the photoconductor to be in the semi-engaged position for the cleaning station to engage, and thus may be programmed to operate in the manner discussed above to increase the wetting margin. The controller 450 may be to perform the methods 600 and/or 700 as will now be described with reference to FIGS. 6 and 7, respectively, and may comprise the processor 804 and/or machine-readable medium 800 as will be described with reference to FIG. 8.

FIG. 6 shows an example method 600 which may comprise a computer-implemented method. The method 600 may comprise a method of cleaning a photoconductor (or photoconductor surface) or a photoreceptor (or photoreceptive surface) of a print apparatus. The method 600 may comprise a method of controlling the position of a photoconductor (or photoreceptor or photoconductive or photoreceptive surface etc.) during a cleaning operation.

The method comprises, at block 602, moving, by a processor, a photoreceptor of a print apparatus. The photoreceptor is movable between a fully engaged position in which the photoreceptor is to engage a transfer member of the print apparatus to transfer a fluid image from the photoreceptor to the transfer member and a fully disengaged position in which the photoreceptor is remote from the transfer member. Block 602 comprises moving the photoreceptor to an intermediate position between the fully engaged and fully disengaged positions. The print apparatus may comprise the print apparatus 100 or print apparatus 400 as described above and the photoreceptor may comprise the photoconductors 102, 402 as described above, and the transfer member may comprise the transfer member, or movable component, 110, 410 as described above. Therefore, the “intermediate position” of the photoreceptor, to which the photoreceptor is moved at block 602, may comprise the semi-engaged position as described above and with reference to FIG. 3C.

At block 604 the method comprises engaging, by a processor, a cleaning system of the print apparatus with the photoreceptor to clean and/or cool the photoreceptor when the photoreceptor is in the intermediate position. Block 602 may comprise causing, by a processor, the cleaning system to engage the photoreceptor. The cleaning system may comprise the cleaning system 116 or 416 as described above and therefore may comprise a first cleaning element, a second cleaning element and/or a wiper (e.g. a wiper blade). As stated above, the first and second cleaning elements may each, or both, comprise a sponge roller and/or a wetting roller and/or a squeegee roller) or other than a roller, for example a squeegee (for example a resiliently deformable element) that is to indent a sponge to cause fluid to flow from the spongeTherefore, block 604 may cause the cleaning system to engage the photoreceptor when the photoreceptor is at a position so as to increase the advection time window and wetting margin and therefore to reduce the conditions, or timed interval, during which dry-contact can occur. The method 600 may therefore reduce the instances of damage to the photoreceptor surface and/or a wiper of the cleaning system, accommodate for sponge rollers of varying diameter, and increase the lifespan of the photoreceptor and/or wiper as described above. The controller 450 described above may be to perform block 602 and/or block 604 of the method 600.

FIG. 7 shows an example method 700 which may comprise a computer-implemented method. The method 700 may comprise a method of cleaning a photoconductor (or photoconductor surface) or a photoreceptor (or photoreceptive surface) of a print apparatus. The method 700 may comprise a method of controlling the position of a photoconductor (or photoreceptor or photoconductive or photoreceptive surface etc.) during a cleaning operation. The method comprises block 702 at which the print apparatus is placed in a READY-TO-PRINT state, block 704 at which the print apparatus is placed in a PRE-PRINT state, and block 706 at which the print apparatus is placed in a PRINT state, for example as described above and with reference to FIG. 5.

At block 708 the method comprises causing, by a processor, the transfer member to rotate. For example block 708 may comprise causing the transfer member to rotate at a slow speed, for example a speed that is slower than the speed the transfer member is to rotate during a print operation. At block 710 the method comprises causing, by a processor, the photoreceptor to move to the intermediate position (e.g. the semi-engage position). Block 710 may comprise moving, by a processor, the photoreceptor to the intermediate position. At block 712 the method comprises causing, by a processor, the cleaning system to disengage the photoreceptor. For example, block 712 may comprise moving the cleaning system, or causing the cleaning system to move to, its disengaged position. A READY-TO-PRINT (or READY) state, or sequence, of the print apparatus may comprise blocks 708-712.

At block 714 the method comprises causing, by a processor, the transfer member to accelerate, for example to a full speed, for example to a speed at which the transfer member is to rotate during a print operation. Block 714 may comprise rotating, by a processor, the transfer member, e.g. at the full speed described. At block 716 the method comprises causing, by a processor, the photoreceptor to be in its semi-engage position. For example, block 716 may be to cause the photoreceptor to remain in its semi-engage position. The photoreceptor may therefore remain in the intermediate position in both the READY and PRE-PRINT states. At block 718 the method comprises causing, by a processor, the cleaning system to engage the photoreceptor. For example, block 718 may comprise moving the cleaning system, or causing the cleaning system to move to, its engaged position. At block 720 the method comprises causing, by a processor, the photoreceptor (with the cleaning station engaged) to move to the fully engaged position. Block 720 may comprise moving, by a processor, the photoreceptor (with the cleaning station engaged) to the fully engaged position. Therefore, at block 720 the photoreceptor may be moved into a nip-engagement with the transfer member, or may be engaged with the transfer member to form a nip, or contact, or near-contact, whichever position in which the photoreceptor is to perform a print operation (e.g. pre-defined or pre-programmed position). At block 722 the method may comprise maintaining the current state of the print apparatus, for example delaying any subsequent operations. Block 722 may comprise a check to determine if all components of the print apparatus are ready for a print operation. Block 722 may comprise performing any number of checks (e.g. quality control checks) before the method advances to the PRINT sequence, comprising block 726. Any such checks may be performed manually or automatically. The delay is optional and, in some examples, there may be a delay between any of the blocks of the method 700, this delay being to ensure the correct state of the print apparatus. A PRE-PRINT state, or sequence, of the print apparatus may comprise blocks 714-722.

At block 726 the method comprises causing, by a processor, the photoreceptor (with the cleaning station engaged) to move to the fully engaged position. Block 726 may comprise moving, by a processor, the photoreceptor (with the cleaning station engaged) to the fully engaged position. Therefore, at block 726 the photoreceptor may be moved into a nip-engagement with the transfer member, or may be engaged with the transfer member to form a nip. A PRINT state, or sequence, of the print apparatus may comprise block 726. At block 726 the transfer member may be rotating, for example at the same rotational speed as per block 714 in the PRE-PRINT sequence. In other words, the rotational speed to the transfer member may be the same in the PRE-PRINT and PRINT sequences, and therefore the speed may be maintained in the transition from the PRE-PRINT to the PRINT state.

As stated above, then controller 450 of the print apparatus 400 as described above may be to perform the method 600 and/or 700 and therefore any one of the blocks as described above.

FIG. 8 shows an example non-transitory machine-readable, or computer-readable, medium 802 comprising a set of machine-readable instructions 806 stored thereon. The medium 802 is shown in FIG. 8 in association with a processor 804. The controller 450 described above may comprise the medium 802 and/or the processor 804. The instructions 806 when executed by the processor 804 are to cause the processor to perform a task. For example, the instructions 806, when executed by the processor 804, may be to cause the processor 804 to perform the method 600 or 700 as described above, e.g. any of the blocks thereof. The instructions 806, when executed by the processor 804 are to cause the processor to cause a cleaning module (such as the cleaning station 116 or 416 as described above with reference to FIGS. 1-5 or the cleaning system as described above with reference to FIGS. 6-7) to engage a photoconductive surface of a print apparatus (e.g. a photoconductive surface of a photoreceptor or photoreceptive surface of a photoreceptor as described above) to clean and/or cool the photoconductive surface when the photoconductive surface is in an intermediate position between a fully engaged position where the photoconductive surface is to transfer an image to a blanket (for example a heated blanket, e.g. a thermal blanket, for example a blanket of a movable element such as a transfer member, e.g. 110 or 410, as described above) and a fully disengaged position where the photoconductive surface is remote from the blanket. The fully engaged position of the surface may be as described above and as shown in FIG. 3A, the fully disengaged position may be as described above and as shown in FIG. 3B, and the intermediate position may comprise the semi-engaged position as described above and as shown in FIG. 3C. The cleaning module may comprise a sponge roller and/or a wiper as described above with reference to the cleaning station 116. The instructions 806 may therefore be to cause the processor 804 to cause the photoconductive surface to be in the intermediate position, and the cleaning module to engage the surface in the intermediate position, so as to increase the advection time window and wetting margin as described above. The instructions 806 may be to cause the processor 804 to move the photoconductive surface to the intermediate position and engage the cleaning module with the photoconductive surface (e.g. during a READY state or a PRE-PRINT state of the printer), and to move the photoconductive surface, with the cleaning module engaged, into engagement with the blanket (e.g. during a PRINT state of the printer). The instructions 806 may therefore be to cause the processor 804 to cause the printer to operate in a PRE-PRINT state and to cause the photoconductive surface to be in the intermediate position when the printer is operating in the pre-print state (for example as described above with reference to blocks 714-722 of the method 700). The instructions 806 may therefore be to cause the processor 804 to cause the printer to operate in a READY state, cause the photoconductive surface to be in the intermediate position during the READY state (e.g. as described above with reference to blocks 708-712 of the method 700), to cause the printer to transition to a PRE-PRINT state, and to cause the photoconductive surface to be in the intermediate position during the PRE-PRINT state. The instructions 806 may be to cause the printer to operate in a READY state and/or a PRE-PRINT state and/or a PRINT state.

Some examples herein are therefore directed to engaging a cleaning station (e.g. a sponge roller and wiper thereof) to a photoconductive surface of a photoconductor (e.g. a photoconductive drum) to clean and/or cool the surface when the photoconductor is in a semi-engaged position, which as described above may be any “intermediate” position between two extreme positions of the range of movement of the photoconductor. For example, the photoconductor may be movable between an extreme left and an extreme right position (for example) or fully engaged or fully disengaged position, the photoconductor being engaged to the transfer member to form a nip in the fully engaged position, and the intermediate position being any position between these two positions. For example, the intermediate position may be a semi-engaged position where the photoconductor engages the transfer member but does not form a nip, or is proximate the transfer member without touching the transfer member. As above, engaging the cleaning station with the photoconductor with the photoconductor in this position increases the advection time window and wetting margin, thereby decreasing the time during which a dry wiper (of the cleaning station) may contact a dry photoconductive surface. As also described above this may reduce the risk of damage to the wiper and/or the photoconductor surface, and may therefore increase the lifespan of the p photoconductor and/or the wiper, in addition to decreasing the risk of damaging the print quality of a print operation.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
moving, by a processor, a photoreceptor of a print apparatus, the photoreceptor being movable between a fully engaged position in which the photoreceptor is to engage a transfer member of the print apparatus to transfer an image from the photoreceptor to the transfer member and a fully disengaged position in which the photoreceptor is remote from the transfer member, to an intermediate position between the fully engaged and fully disengaged positions; and
engaging, by a processor, a cleaning system of the print apparatus with the photoreceptor when the photoreceptor is in the intermediate position.

2. A method according to claim 1, comprising:
operating, by a processor, the print apparatus in a pre-print state,
wherein the cleaning station is engaged with the photoreceptor in the intermediate position when the print apparatus is operating in its pre-print sequence.

3. A method according to claim 1, comprising:
operating, by a processor, the print apparatus in a pre-print state,
wherein the photoreceptor is not placed in the fully disengaged position during the pre-print sequence.

4. A method according to claim 1, comprising:
operating, by a processor, the print apparatus in a ready-to-print state, and
operating, by a processor, the print apparatus in a pre-print state, the method further comprising:
maintaining, by a processor, intermediate position of the photoreceptor when the print apparatus transitions from its ready-to-print state to its pre-print state.

5. A method according to claim 1, comprising, during a pre-print state of the print apparatus:
causing, by a processor, the transfer member to rotate;
moving, by a processor, the photoreceptor to the intermediate position and engaging the cleaning system with the photoreceptor;
moving, by a processor, the photoreceptor, with the cleaning system engaged, to the fully engaged position to engage the photoreceptor with the transfer member;
moving, by a processor, the photoreceptor, with the cleaning system engaged, to the intermediate position.

6. A method according to claim 5, further comprising, after a predetermined time period has elapsed,
moving, by a processor, the photoreceptor, with the cleaning system engaged, to the intermediate position; and, during a printing state of the print apparatus,
moving, by a processor, the photoreceptor, with the cleaning system engaged, to the fully engaged position to engage the photoreceptor to the transfer member.

7. A print apparatus comprising:
a photoconductor movable between a fully engaged position, in which the photoconductor is to engage a movable component of the print apparatus to transfer an image formed on a surface of the photoconductor to the movable component, and a fully disengaged position, in which the photoconductor is remote from the movable component;
a cleaning station to clean a surface of the photoconductor, the cleaning station being movable between an engaged position in which the cleaning station is to engage the photoconductor and a disengaged position in which the cleaning station is remote form the photoconductor; and
a controller to cause the cleaning station to engage the photoconductor when the photoconductor is in a position between the engaged and fully disengaged positions.

8. A print apparatus according to claim 7, wherein, when the photoconductor is in its fully engaged position the photoconductor forms a first contact area with the movable component of the print apparatus and, when the photoconductor is in the position between the engaged and fully disengaged positions, the photoconductor forms a second contact area with the movable component of the print apparatus, the second contact area being less than the first contact area..

9. A print apparatus according to claim 7, wherein, when the photoconductor is in its engaged position, the photoconductor is to compress the movable component of the print apparatus and, when the photoconductor is in the position between the engaged and fully disengaged positions, the photoconductor is to compress the movable component such that the compressed diameter of the movable component is larger than the compressed diameter of the movable component when the photoconductor is in the engaged position.

10. A print apparatus according to claim 7, wherein the controller is to cause the print apparatus to operate in a ready-to-print state and a print state and is to cause the print apparatus to transition from the ready-to-print state to the print state, and wherein the controller is to cause the cleaning station to engage the photoconductor to clean the photoconductor when the photoconductor is in a position between the engaged and fully disengaged positions during the transition from the ready-to-print state to the print state.

11. A print apparatus according to claim 10, wherein the controller is to cause the photoconductor to maintain its position during the transition from the ready-to-print state to the print state.

12. A non-transitory computer-readable storage medium comprising a set of computer-readable instructions stored thereon which, when executed by a processor, cause the processor to:
cause a cleaning module of a printer to engage a photoconductive surface of a printer to clean the photoconductive surface when the photoconductive surface is in an intermediate position between a fully engaged position where the photoconductive surface is to transfer an image to a blanket and a fully disengaged position where the photoconductive surface is remote from the blanket.

13. A non-transitory computer-readable storage medium according to claim 12, wherein the instructions, when executed by the processor, cause the processor to:
cause the printer to operate in a pre-print state; and to
cause the photoconductive surface to be in the intermediate position when the printer is operating in the pre-print state.

14. A non-transitory computer-readable storage medium according to claim 12, wherein the instructions, when executed by the processor, cause the processor to:
cause the printer to operate in a ready-to-print state;
cause the photoconductive surface to be in the intermediate position during the ready-to-print state;
cause the printer to transition to a pre-print state; and to
cause the photoconductive surface to be in the intermediate position during the pre-print state.

15. A non-transitory computer-readable storage medium according to claim 12, wherein the instructions, when executed by the processor, cause the processor to:
move the photoconductive surface to the intermediate position and engage the cleaning module with the photoconductive surface; and to
move the photoconductive surface, with the cleaning module engaged, into engagement with the blanket.
